(19) United States
(12) Patent Application Publication
(10) Pub. No.: US 2012/0224464 A1
(43) Pub. Date: Sep. 6, 2012

(54) SERVO CONTROLLER AND SERVO SYSTEM INCLUDING THE SAME

(76) Inventor: Soo-Yong KIM, Hwaseong-si (KR)

(21) Appl. No.: 13/407,233

(22) Filed: Feb. 28, 2012

(30) Foreign Application Priority Data
Mar. 2, 2011 (KR) 10-2011-0018300

(51) Int. Cl. G11B 7/085; G05B 11/01

(52) U.S. Cl. 369/47.4; 700/71; G9B/7.042

(57) ABSTRACT

A servo controller in a system includes a kick/brake control unit and a compensation unit. The kick/brake control unit determines an internal parameter based on an external control signal and an operation state of a plant. The compensation unit generates a driving control signal based on an error signal supplied from the plant and the internal parameter, and supplies the driving control signal to the plant. The plant performs a steady-state operation during a first operation mode and a target moving operation during a second operation mode based on the driving control signal.

### CROSS-REFERENCE TO RELATED APPLICATION

This application claims priority under 35 USC §119 to Korean Patent Application No. 2011-0018300, filed on Mar. 2, 2011 in the Korean Intellectual Property Office (KIPO), the disclosure of which is incorporated by reference in its entirety herein.

### TECHNICAL FIELD

Exemplary embodiments of the inventive concept relate to a controller, and more particularly to a servo controller and a servo system including the servo controller.

### DISCUSSION OF RELATED ART

A servo system includes a servo controller and a plant. The plant may be a machine or other device, the operation of which is controlled by the servo controller. The servo controller receives one or more feedback signals that are representative of one or more outputs of the plant. The servo controller processes the feedback signals and supplies a control signal to operate the plant. To control the plant to follow a target operation, the servo controller can adjust a control value of the control signal such that the control value matches a target value and an error value corresponding to a difference between the control value and the target value is minimized. The servo controller may be employed in various mechanical systems such as a robot, a ship or a plane to automatically control a moving object in the mechanical systems. For example, an optical disc driving device may include the servo controller for adjusting a focus of light projected on an optical disc.

### SUMMARY

According to an exemplary embodiment of the inventive concept, a servo controller in a system including a plant includes a kick/brake control unit and a compensation unit. The kick/brake control unit determines an internal parameter based on an external control signal and an operation state of the plant. The compensation unit generates a driving control signal based on an error signal supplied from the plant and the internal parameter, and supplies the driving control signal to the plant. The plant performs a steady-state operation during a first operation mode and a target moving operation during a second operation mode based on the driving control signal.

The kick/brake control unit may set the internal parameter to a kick parameter when the external control signal is transitioned from a deactivation level to an activation level during the second operation mode, and may set the internal parameter to a brake parameter when the external control signal is maintained at the activation level and the error signal complies with a brake criterion during the second operation mode. The kick parameter may be used to start the target moving operation of the plant, and the brake parameter may be used to finish the target moving operation of the plant.

The compensation unit may adjust a level of the driving control signal based on the kick parameter during a first time period of the second operation mode, and may adjust the level of the driving control signal based on the brake parameter and the error signal during a second time period of the second operation mode. The internal parameter may be set to the kick parameter during the first time period of the second operation mode, and may be set to the brake parameter during the second time period of the second operation mode.

The driving control signal may have a kick peak value at a starting point of the first time period of the second operation mode, and may exponentially increase or decrease during the first time period of the second operation mode. The driving control signal may have a brake peak value at a starting point of the second time period of the second operation mode, and may exponentially increase or decrease during the second time period of the second operation mode.

The compensation unit may cut off the error signal received from the plant during the first time period of the second operation mode, and may allow the error signal to be received from the plant during the second time period of the second operation mode.

The kick/brake control unit may set the internal parameter to a normal parameter when the external control signal is transitioned from the activation level to the deactivation level during the first operation mode. The normal parameter may be used to perform the steady-state operation of the plant.

The target moving operation of the plant may indicate that a driven device included in the plant moves from a first position to a second position. The kick parameter may be determined based on disturbance of the plant, a target distance between the first position and the second position, and a target time required to move the driven device from the first position to the second position.

The brake parameter may be determined based on a velocity of the driven device at a point in time at which the error signal complies with the brake criterion.

The compensation unit may be an N-th order digital filter having N stages, where N is greater than >=two. Each stage in the N-th order digital filter may have a delay memory. The kick/brake control unit may correspond to one of the delay memories.

The kick/brake control unit may correspond to a delay memory that is included in a last stage of the N stages that is adjacent an output terminal of the N-th order digital filter.

According to an exemplary embodiment of the inventive concept, a servo system includes a plant, a servo controller and a driver. The plant includes a driven device. The driven device performs a steady-state operation during a first operation mode and a target moving operation during a second operation mode based on a driving signal. The servo controller determines an internal parameter based on an external control signal and an operation state of the driven device, and generates a driving control signal based on an error signal and the internal parameter. The error signal corresponds to a position or a velocity of the driven device. The driver generates the driving signal based on the driving control signal.

The servo system may further include a sensor. The sensor may generate a feedback signal by detecting a current position or a current velocity of the driven device.

The servo system may further include a calculator and an amplifier. The calculator may generate a difference signal by subtracting the feedback signal from a reference signal. The amplifier may generate the error signal by amplifying the difference signal.

The servo controller may set the internal parameter to a kick parameter when the external control signal is transitioned from a deactivation level to an activation level during the second operation mode, and may set the internal parameter to a brake parameter when the external control signal is maintained at the activation level and the error signal complies with a brake criterion during the second operation mode. The kick parameter may be used to start the target moving operation of the driven device and the brake parameter may be used to finish the target moving operation of the driven device. The amplifier may temporarily initialize the error signal during a time period of the second operation mode during which the internal parameter is set to the kick parameter.

The servo system may be a system that drives an optical disc that has a plurality of data layers. Each data layer may store data and may have a different depth from a surface of the optical disc. The servo controller may be a focus servo controller that controls a layer-jump operation to move a light spot projected on the optical disc from a first data layer to a second data layer of the plurality of data layers.

A servo system according to an exemplary embodiment of the inventive concept includes a controller and a compensating unit. The controller is configured to output a first value during a first period of an activated control signal, and output a second other value during a second remaining period of the activated control signal. The compensating unit is configured to generate a first driving signal to start moving a device of the system when the output is the first value, and generate a second driving signal based on an error signal to stop moving the device when the output is the second value.

The controller may output a third value different from the first and second values when the control signal is deactivated. The compensating unit can then generate a third driving signal to maintain a position of the driven device at a pre-defined position or within a pre-defined position range when the output is the third value. The servo system may include a unit that outputs the error signal to the compensating unit with a reduced voltage when a voltage of the error signal differs from a pre-defined breaking voltage. Alternately, the servo system may include an amplifier that outputs the error signal, where a gain of the amplifier is set to zero during the first period. The servo system may further include a sensor and an adder. The sensor may be configured to determine a current position of the device and the adder may be configured to output a difference of a reference signal and the determined position to the amplifier.

### BRIEF DESCRIPTION OF THE DRAWINGS

Exemplary embodiments of the inventive concept will be more clearly understood from the following detailed description taken in conjunction with the accompanying drawings.

FIG. 1 is a block diagram illustrating a servo controller according to an exemplary embodiment of the inventive concept.

FIG. 2 is a block diagram illustrating an example of the servo controller of FIG. 1 according to an exemplary embodiment of the inventive concept.

FIG. 3 is a flow chart illustrating a method of driving the servo controller of FIG. 1 according to an exemplary embodiment of the inventive concept.

FIG. 4 is a flow chart illustrating an example of step S200 in FIG. 3 according to an exemplary embodiment of the inventive concept.

FIG. 5 is a flow chart illustrating an example of step S220 in FIG. 4 according to an exemplary embodiment of the inventive concept.

FIG. 6 is a flow chart illustrating an example of step S240 in FIG. 4 according to an exemplary embodiment of the inventive concept.

FIGS. 7A, 7B, 7C and 7D are diagrams for describing exemplary operations of the servo controller of FIG. 1.

FIG. 8 is a block diagram illustrating a servo system according to an exemplary embodiment of the inventive concept.

FIG. 9 is a block diagram illustrating an optical disc driving device according to an exemplary embodiment of the inventive concept.

FIG. 10 is a cross-sectional view illustrating an example of an optical disc that may be used in the optical disc driving device of FIG. 9.

FIGS. 11A, 11B, 12A, 12B, 13A, 13B, 14A, 14B, 15A and 15B are diagrams for describing exemplary operations of the optical disc driving device of FIG. 9.

### DETAILED DESCRIPTION

The inventive concept will be described more fully with reference to the accompanying drawings, in which exemplary embodiments thereof are shown. The inventive concept may, however, be embodied in many different forms and should not be construed as limited to the exemplary embodiments set forth herein. Like reference numerals refer to like elements throughout this application.

It will be understood that when an element is referred to as being “connected” or “coupled” to another element, it can be directly connected or coupled to the other element or intervening elements may be present.

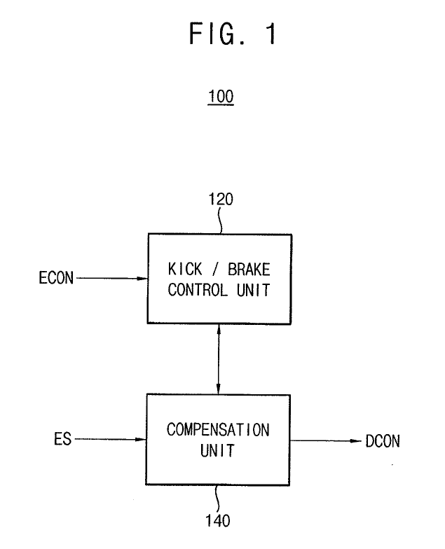

FIG. 1 is a block diagram illustrating a servo controller according to an exemplary embodiment of the inventive concept.

Referring to FIG. 1, a servo controller 100 includes a kick/brake control unit 120 and a compensation unit 140.

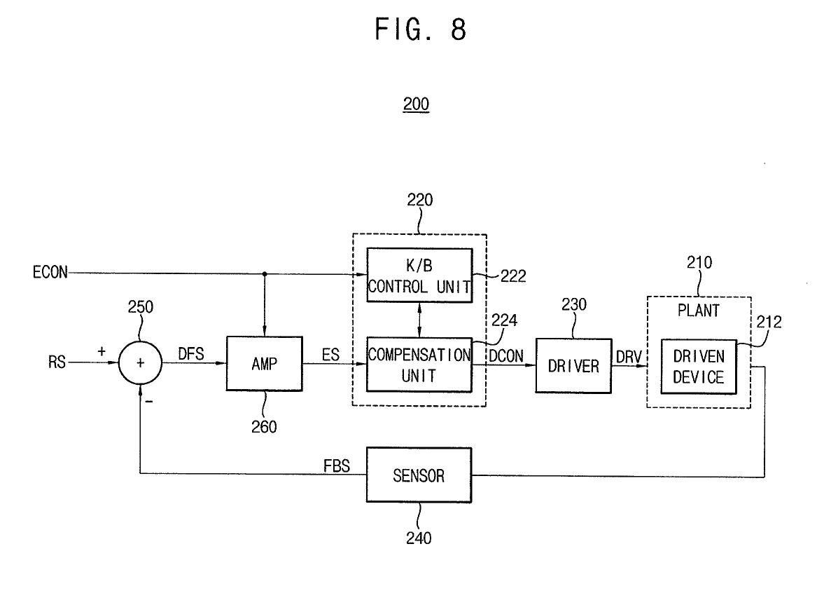

A servo system may include the servo controller 100 and a plant (not illustrated). The servo system may control operations of the plant by using the servo controller 100. The servo system including the servo controller 100 and the plant may operate alternatively in two modes (e.g., a first operation mode and a second operation mode). The first operation mode may be referred to as a steady-state operation mode, and the second operation mode may be referred to as a transient operation mode. The servo system may perform different operations depending on the operation mode. Exemplary embodiments of the servo system will be described below with reference to FIG. 8.

The kick/brake control unit 120 determines an internal parameter based on an external control signal ECON and an operation state of the plant. The internal parameter may be used to generate a driving control signal DCON and to control the operations of the plant. The kick/brake control unit 120 may include a memory that stores the internal parameter.

The kick/brake control unit 120 may receive the external control signal ECON from an external device such as a main controller controlling the servo system. The operation mode of the servo system and the servo controller 100 may be determined based on the external control signal ECON. For example, the operation mode of the servo controller 100 may be changed from the first operation mode to the second operation mode when the external control signal ECON is activated, and may be changed from the second operation mode to the first operation mode when the external control signal ECON is deactivated.

As used herein, the terms “activated” and/or “activation” may indicate that a signal is transitioned from a first logic level (e.g. a deactivation level) to a second logic level (e.g., an activation level), and the terms “deactivated” and/or “deactivation” may indicate that the signal is transitioned from the second logic level to the first logic level. The first logic level may be a logic low level, and the second logic level may be a logic high level, or vice versa.

The compensation unit 140 generates the driving control signal DCON based on an error signal ES and the internal parameter. The internal parameter may be output from the kick/brake control unit 120 to the compensation unit. The error signal ES may be supplied from the plant to the compensation unit 140, and may correspond to a position and/or a velocity of a driven device included in the plant. For example, the error signal ES may correspond to a position difference between a predetermined target position and a current position of the driven device. Alternatively, the error signal ES may correspond to a velocity difference between a predetermined target velocity and a current velocity of the device. The compensation unit 140 supplies the driving control signal DCON to the plant. The plant performs a steady-state operation in the first operation mode and a target moving operation in the second operation mode based on the driving control signal DCON.

In an exemplary embodiment of the inventive concept, the steady-state operation may indicate that a position of the driven device is maintained at a predetermined first position (e.g., a target position) or in a predetermined position range (e.g., a target position range), in other words, the driven device maintains a steady-state. For example, if the position of the driven device is out of the target position or the target position range in the first operation mode, the position of the driven device may be compensated based on the driving control signal DCON. For example, compensation of the position by the driving control signal DCON may cause the driven device to be moved to either the target position or a position within the target position range. The target moving operation may indicate that the driven device is moved from a predetermined second position (e.g., an initial position) to a predetermined third position (e.g., a final position), in other words, the driven device operates in a transient state.

In an exemplary embodiment of the inventive concept, the steady-state operation may indicate that a velocity of the driven device is maintained at a predetermined first velocity (e.g., a target velocity) or in a predetermined velocity range (e.g., a target velocity range). The target moving operation may indicate that the velocity of the driven device is changed from a predetermined second velocity (e.g., an initial velocity) to a predetermined third velocity (e.g., a final velocity).

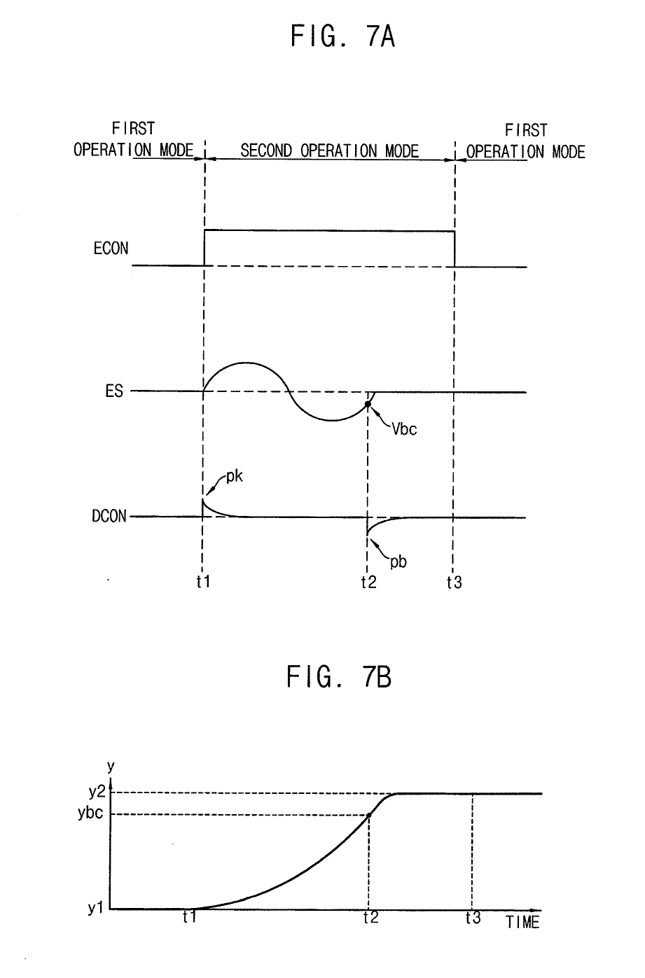

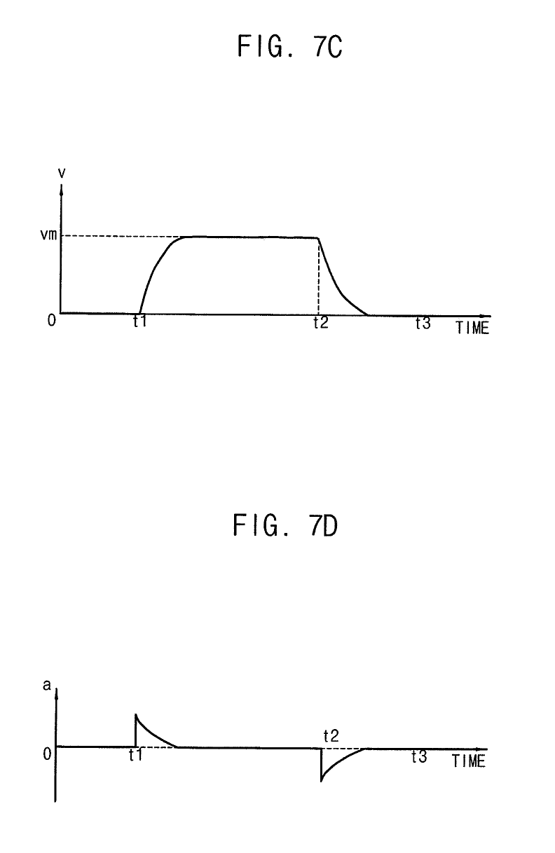

As described below with reference to FIG. 7A, during an initial operation time, the servo controller 100 may operate in the first operation mode. During the first operation mode, the external control signal ECON may have the deactivation level (e.g., the logic low level), and the internal parameter may be set to a normal parameter that is used to perform the steady-state operation of the plant. When the external control signal ECON is transitioned from the deactivation level to the activation level (e.g., the logic high level), the servo controller 100 may enter the second operation mode, and the kick/brake control unit 120 may set the internal parameter to a kick parameter that is used to start the target moving operation of the plant. When the external control signal ECON is maintained at the activation level and the error signal ES complies with a brake criterion in the second operation mode, the kick/brake control unit 120 may set the internal parameter to a brake parameter that is used to finish the target moving operation of the plant. The second operation mode may be divided into a first time period and a second time period depending on the internal parameter. For example, during the first time period, the driving control signal DCON may be set to a first waveform to overcome the initial inertia of the driven device using the kick parameter, and during the second time period, the driving control signal DCON may be set to a different second waveform to slow and eventually stop the driven device using the brake parameter. When the external control signal ECON is transitioned from the activation level to the deactivation level, the servo controller 100 may re-enter the first operation mode, and the kick/brake control unit 120 may set the internal parameter to the normal parameter.

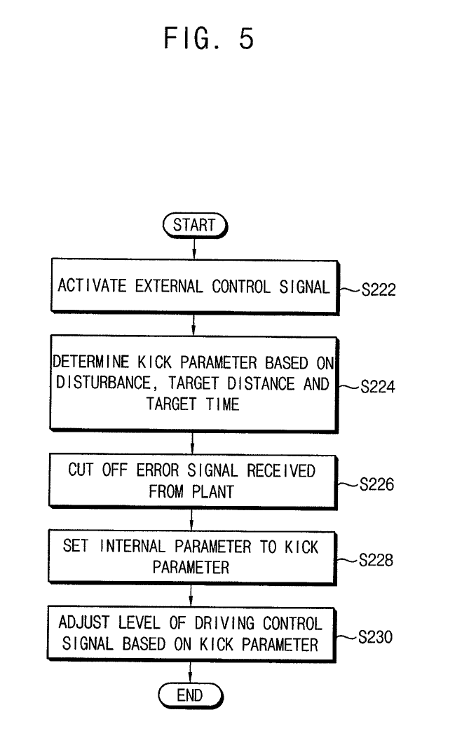

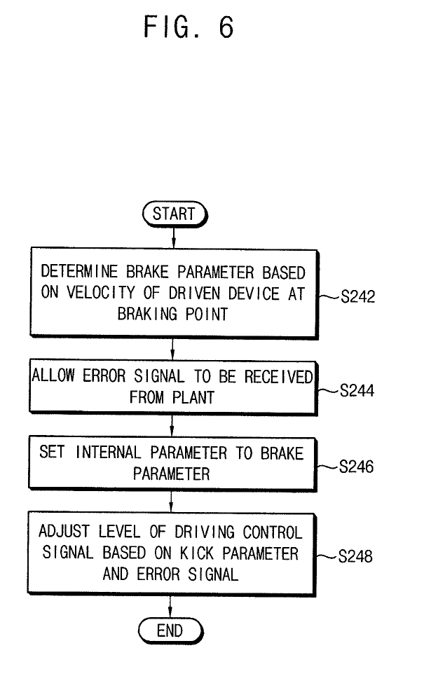

Thus, the kick/brake control unit 120 may determine the internal parameter based on the operation mode of the servo controller 100 (e.g., whether the servo controller 100 operates in the first operation mode or in the second operation mode) and the operation state of the plant (e.g., whether the target moving operation of the plant is started or finished). As described below with reference to FIGS. 5 and 6, the normal parameter, the kick parameter and the brake parameter may be defined depending on operating environments of the servo system.

A servo controller in a servo system may include a first compensation unit and a second compensation unit that are alternately enabled. For example, the first compensation unit is enabled to control a steady-state operation of a plant in a steady-state operation mode, and is disabled in a transient operation mode. The second compensation unit is enabled to control a target moving operation of the plant in the transient operation mode, and is disabled in the steady-state operation mode. However, such a configuration may require complicated logic. In addition, use of the two compensation units in the servo controller may cause an overshoot of a driven device included in the plant at an ending point of the transient operation mode since it is difficult to reduce a terminal velocity of the driven device at the ending point of the transient operation mode to about zero, due to uncertainty of the servo system such as a disturbance of the plant, a perturbation of the plant, etc. Thus, a servo system including a servo controller having the two compensation units may have relatively low operation reliability and low operation stability.

As discussed above, the servo controller 100 according to an exemplary embodiment of the inventive concept includes the kick/brake control unit 120 and the compensation unit 140. The kick/brake control unit 120 changes the internal parameter depending on the operation mode of the servo controller 100 and the operation state of the plant, and the compensation unit 140 generates the driving control signal DCON for controlling the plant in both of the first and second operation modes based on the internal parameter. In other words, the servo controller 100 includes a single compensation unit 140 that is always enabled (e.g., enabled in both of the first and second operation modes), instead of two compensation units that are alternately enabled depending on the operation mode. In addition, the internal parameter may be determined depending on operating environments of the servo system such as the disturbance of the plant, the perturbation of the plant, etc. Thus, the servo system including the servo controller 100 may have relatively high operation reliability and high operation stability.

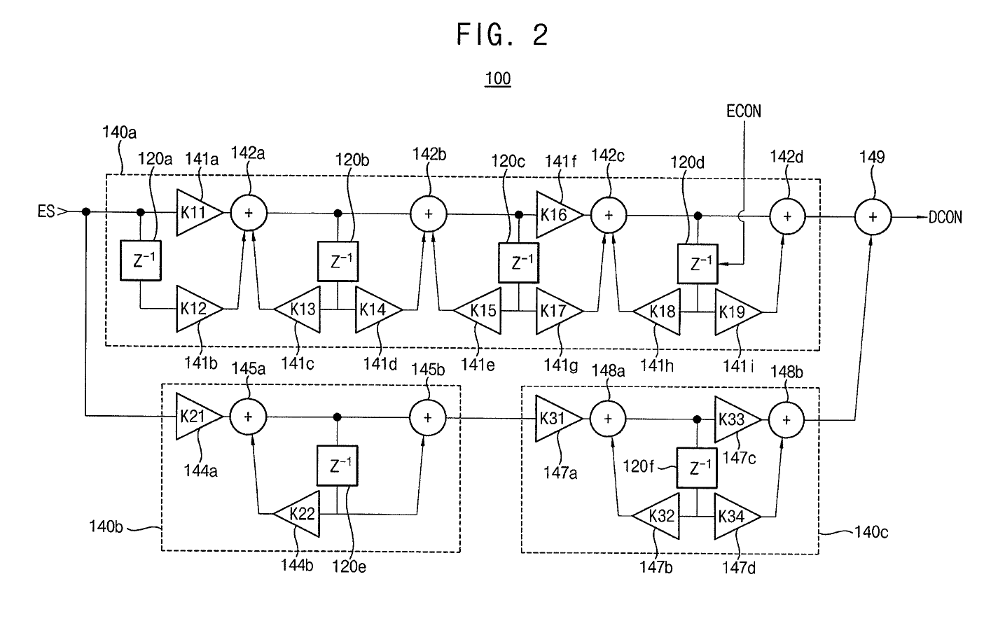

FIG. 2 is a block diagram illustrating an example of the servo controller of FIG. 1 according to an exemplary embodiment of the inventive concept.

Referring to FIG. 2, the servo controller 100 may be implemented with a digital filter, and may include a first filter block 140a, a second filter block 140b, a third filter block 140cand an adder 149.

The servo controller 100 may be an N-th order digital filter having N stages, where N is a natural number >=two. Each stage in the N-th order digital filter may have a delay memory. An order of the digital filter may correspond to the number of the delay memories in the digital filter. FIG. 2 illustrates a sixth order digital filter including six stages, where each has a respective one of six delay memories 120a, 120b, 120c, 120d, 120e and 120f.

The first filter block 140a may filter the error signal ES. The second filter block 140b may filter the error signal ES, and the third filter block 140c may filter an output signal of the second filter block 140c. The adder 149 may generate the driving control signal DCON by adding an output signal of the third filter block 140c to an output signal of the first filter block 140a. The second filter block 140b may be connected in series with the third filter block 140c, and the first filter block 140a may be connected in parallel with the serially-connected second and third filter blocks 140b and 140c.

The filter blocks 140a, 140b and 140c may operate at different sampling frequencies. For example, the first filter block 140a may operate at a sampling frequency of about 176 kHz. The second filter block 140b may operate at a sampling frequency of about 88 kHz. The third filter block 140c may operate at a sampling frequency of about 22 kHz. However, the provided sampling frequencies are merely examples, and may be changed to various amounts, as necessary.

Each of filter blocks 140a, 140b and 140c may include at least one delay memory, at least one coefficient memory and at least one adder. For example, the first filter block 140a may include delay memories 120a, 120b, 120c and 120d, coefficient memories 141a, 141b, 141c, 141d, 141e, 141f, 141g, 141h and 141i, and adders 142a, 142b, 142c and 142d. The second filter block 140b may include a delay memory 120e, coefficient memories 144a and 144b, and adders 145a and 145b. The third filter block 140c may include a delay memory 120f, coefficient memories 147a, 147b, 147c and 147d, and adders 148a and b 148b.

Each of the coefficient memories 141a, 141b, 141c, 141d, 141e, 141f, 141g, 141h, 141i, 144a, 144b, 147a, 147b, 147c and 147d may store at least one coefficient corresponding to a characteristic of the digital filter. For example, each of the coefficient memories 141b, 141d, 141g, 141i and 147d may store a coefficient corresponding to a zero value of a transfer function for the digital filter. Each of the coefficient memories 141c, 141e, 141h, 144b and 147b may store a coefficient corresponding to a pole value of the transfer function for the digital filter. Each of the coefficient memories 141a, 141f, 144a, 147a and 147c may store a coefficient corresponding to a gain of the transfer function (e.g., a magnitude of the driving control signal DCON) for the digital filter.

Each of the delay memories 120a, 120b, 120c, 120d, 120e and 120f may store information with respect to previous input/output (I/O) signals that are received from or supplied to the plant prior to the current I/O signals. The information stored in each of the delay memories 120a, 120b, 120c, 120d, 120e and 120f may indicate an internal state of the digital filter.

When the servo controller 100 is implemented with the digital filter, the kick/brake control unit 120 in FIG. 1 may correspond to one of the delay memories 120a, 120b, 120c, 120d, 120e and 120f. The compensation unit 140 in FIG. 1 may correspond to the entire digital filter. In other words, the kick/brake control unit 120 and the compensation unit 140 in FIG. 1 may share a part of the digital filter (e.g., one of the delay memories 120a, 120b, 120c, 120d, 120e and 120f).

In an exemplary embodiment of the inventive concept, the kick/brake control unit 120 in FIG. 1 may correspond to the delay memory 120d that is included in the last stage of the N (e.g., six) stages and is adjacent an output terminal of the N-th (e.g., sixth) order digital filter. In this embodiment, as described above with reference to FIG. 1, the internal parameter may be set to one of the normal parameter, the kick parameter and the brake parameter, and the delay memory 120d may store one of the normal parameter, the kick parameter and the brake parameter as the internal parameter. The internal state of the digital filter may vary by changing the internal parameter, which may be referred to as an internal state manipulation (ISM) scheme.

In an exemplary embodiment of the inventive concept, the kick/brake control unit 120 in FIG. 1 corresponds to one of the delay memories 120a, 120b and 120c, which is located at an earlier stage than the last stage including the delay memory 120d. An earlier stage in the digital filter may filter a signal having frequency that is lower than a signal filtered by a later stage. Thus, if the plant requires relatively high energy for starting and/or finishing the target moving operation, the kick/brake control unit 120 may be implemented with one of the delay memories 120a, 120b and 120c such that the servo controller 100 may provide the driving control signal DCON having relatively high energy to the plant and to the driven device included in the plant.

Although a digital filter (e.g., the servo controller 100) having six stages is illustrated in FIG. 2, the number of stages included in the digital filter is not limited thereto. The plurality of stages included in the digital filter may be connected in series, in parallel or a combination thereof, according to exemplary embodiments of the inventive concept. In addition, although the servo controller 100 illustrated in FIG. 2 is implemented with an infinite impulse response (IIR) filter, the servo controller 100 may be implemented with various embodiments such as a finite impulse response (FIR) filter, a proportional-plus-integrate-plus-derivative (PID) controller, a lag-lead controller, etc. A FIR filter is a type of signal processing filter whose impulse response is of finite duration because it can settle to zero in a finite time. A PID is a control loop feedback mechanism that calculates an error value as the difference between a measured process variable and a desired set point. The PID may use three separate constant parameters, a proportional value, an integral value, and a derivative value. A lag-lead compensator may be used to improve undesirable frequency responses in a feedback and control system.

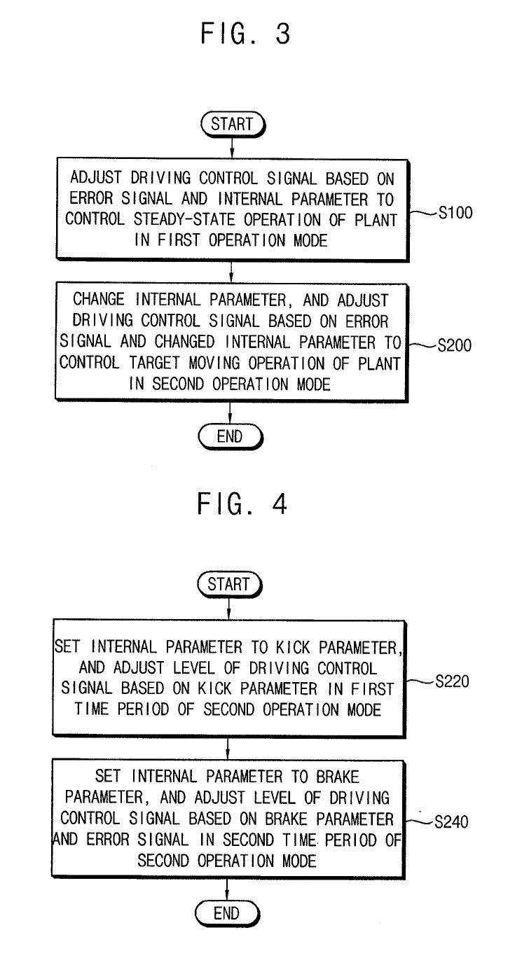

FIG. 3 is a flow chart illustrating a method of driving the servo controller of FIG. 1 according to an exemplary embodiment of the inventive concept.

Referring to FIGS. 1 and 3, the servo controller 100 generates the driving control signal DCON based on the error signal ES and the internal parameter. The compensation unit 140 adjusts a level of the driving control signal DCON based on the error signal ES and the internal parameter to control the steady-state operation of the plant in the first operation mode (step S100). For example, the internal parameter may be set to the normal parameter. A position of the driven device included in the plant may be maintained at the initial position (e.g., the target position) based on the driving control signal DCON in the first operation mode.

The kick/brake control unit 120 changes the internal parameter based on the external control signal ECON and the operation state of the plant in the second operation mode, and the compensation unit 140 adjusts the level of the driving control signal DCON based on the error signal ES and the changed internal parameter to control the target moving operation of the plant in the second operation mode (step S200). The driven device may be moved from the initial position to the final position based on the driving control signal DCON in the second operation mode.

FIG. 4 is a flow chart illustrating an example of step S200 in FIG. 3 according to an exemplary embodiment of the inventive concept.

Referring to FIGS. 1, 3 and 4, in the step S200, the kick/brake control unit 120 may set the internal parameter to the kick parameter when the external control signal ECON is transitioned from the deactivation level to the activation level (e.g., at a starting point of the first time period of the second operation mode), and the compensation unit 140 may adjust the level of the driving control signal DCON based on the kick parameter in the first time period of the second operation mode (step S220). The driven device may be moved away from the initial position at the starting point of the first time period of the second operation mode, and may be moved toward the final position during the first time period of the second operation based on the driving control signal DCON. In an exemplary embodiment of the inventive concept, as illustrated in FIG. 5, the compensation unit 140 may cut off the error signal ES received from the plant during the first time period of the second operation mode.

In an exemplary embodiment, the kick/brake control unit 120 sets the internal parameter to the brake parameter when the external control signal ECON is maintained at the activation level and the error signal ES complies with the brake criterion (e.g., at a starting point of the second time period of the second operation mode), and the compensation unit 140 adjusts the level of the driving control signal DCON based on the brake parameter and the error signal ES in the second time period of the second operation mode (step S240). The driven device may arrive at the final position and the position of the driven device may be maintained at the final position during the second time period of the second operation based on the driving control signal DCON. In an exemplary embodiment of the inventive concept, as illustrated in FIG. 6, the compensation unit 140 allows the error signal ES to be received from the plant during the second time period of the second operation mode.

FIG. 5 is a flow chart illustrating an example of step S220 in FIG. 4 according to an exemplary embodiment of the inventive concept. FIG. 6 is a flow chart illustrating an example of step S240 in FIG. 4 according to an exemplary embodiment of the inventive concept.

Referring to FIGS. 1, 4 and 5, in an embodiment of the step S220 (e.g., in the first time period of the second operation mode), a main controller (not illustrated) controlling the servo system activates the external control signal ECON (step S222). The servo controller 100 starts to operate in the second operation mode. As described above, the plant may perform the target moving operation in the second operation mode, and the target moving operation may indicate that the driven device is to be moved from the initial position to the final position.

The kick parameter may be determined based on a disturbance of the plant, a target distance between the initial position and the final position, and a target time required to move the driven device from the initial position to the final position (step S224). The servo system including the servo controller 100 and the plant may be modeled as a predetermined control system such as a mass-spring-damper system, and the kick parameter may be determined from an equation (e.g., a transfer function) obtained by the modeled control system. For example, a mass-spring-damper system may be subject to an oscillatory force based on a spring constant of the spring and a damping force based on a damping coefficient of the damper. In an exemplary embodiment of the inventive concept, the servo controller 100 further includes a calculation unit (not illustrated) for calculating the kick parameter based on the obtained equation. In another exemplary embodiment of the inventive concept, the kick parameter is predetermined by a designer of the servo system.

In an embodiment, the compensation unit 140 cuts off the error signal ES received from the plant during the first time period of the second operation mode (step S226). For example, the compensation unit 140 or a unit that outputs the error signal ES to the compensating unit 140 may reduce a voltage level of the error signal to a lower level (e.g., OV). The error signal ES may have a characteristic that is opposite to a characteristic of the kick parameter. For example, the error signal ES may be used to adjust the driving control signal DCON for maintaining the position of the driven device, and the kick parameter may be used to adjust the driving control signal DCON for moving the driven device. Thus, the compensation unit 140 may cut off the error signal ES before the internal parameter is set to the kick parameter, and thus malfunctions of the servo controller 100 may be prevented. In an exemplary embodiment of the inventive concept, the error signal ES is cut off by adjusting a gain of an amplifier (not illustrated) that is included in the servo system and generates the error signal ES. In an exemplary embodiment of the inventive concept, the error signal ES is cut off by using a switch (not illustrated) that is included in the servo controller 100. The switch may be located at an input terminal receiving the error signal ES.

In an embodiment, the kick/brake control unit 120 sets the internal parameter to the kick parameter (step S228). In the embodiment, the compensation unit 140 adjusts the level of the driving control signal DCON based on the kick parameter (step S230). For example, the driving control signal DCON may have a kick peak value at the starting point of the first time period of the second operation mode, and may exponentially increase or decrease during the first time period of the second operation mode. In an alternate embodiment, the exponential increase/decrease may be replaced by a linear increase/decrease.

Referring to FIGS. 1, 4 and 6, in an embodiment of the step S240 (e.g., in the second time period of the second operation mode), the brake parameter is determined based on a velocity of the driven device at a point in time (e.g., a break point) at which the error signal ES complies with the brake criterion (step S242). For example, the error signal ES may comply with the brake criterion when the level of the error signal ES corresponds to a predetermined brake level. The servo system may include a timer (not illustrated) for determining whether the error signal ES complies with the brake criterion. Similarly to the kick parameter, the brake parameter may be calculated based on the obtained equation (e.g., the transfer function for the modeled system), or may be predetermined by the designer of the servo system, according to exemplary embodiments. The brake parameter may be calculated by using a predetermined equation such as a linear quadratic regulator (LQR) equation, a Lyapunov equation, a Ricatti equation, a linear matrix inequality (LMI), etc.

In an exemplary embodiment of the inventive concept, a force for braking the driven device may increase as the velocity of the driven device at the point in time at which the error signal ES complies with the brake criterion (e.g., a velocity of the driven device at a braking point) increases, and thus a magnitude of the brake parameter may increase as the velocity of the driven device at the braking point increases.

In an embodiment, the compensation unit 140 allows the error signal ES to be received from the plant during the second time period of the second operation mode (step S244). For example, the compensation unit 140 may ignore or cut off the error signal ES during the first time period of the first operation period, but not during the second time period. The brake parameter may have a characteristic that is similar to the characteristic of the error signal ES since the brake parameter may be used to adjust the driving control signal DCON for stopping movement of the driven device and maintaining the position of the driven device at the final position. Thus, the compensation unit 140 starts to receive the error signal ES before the internal parameter is set to the brake parameter, and thus the driven device may arrive at the final position.

In an embodiment, the kick/brake control unit 120 sets the internal parameter to the brake parameter (step S246). The compensation unit 140 may adjust the level of the driving control signal DCON based on the brake parameter and the error signal ES (step S248). For example, the driving control signal DCON may have a brake peak value at the starting point of the second time period of the second operation mode, and may exponentially increase or decrease during the second time period of the second operation mode. In an alternate embodiment, the exponential increase/decrease may be replaced with a linear increase/decrease.

FIGS. 7A, 7B, 7C and 7D are diagrams for describing exemplary operations of the servo controller of FIG. 1. FIG. 7A illustrates variations of signals ECON, ES and DCON depending on the operation mode. FIG. 7B illustrates a variation of the position of the driven device depending on the operation mode. FIG. 7C illustrates a variation of a velocity of the driven device depending on the operation mode. FIG. 7D illustrates a variation of an acceleration of the driven device depending on the operation mode.

Referring to FIGS. 1 and 7A, before time t1, the servo controller 100 operates in the first operation mode. The external control signal ECON has the deactivation level (e.g., the logic low level), and the internal parameter is set to the normal parameter. The position of the driven device is maintained at the initial position, and thus the error signal ES and the driving control signal DCON may have fixed levels, respectively.

As described above with reference to FIGS. 4 and 5, at time t1, the external control signal ECON is transitioned from the deactivation level to the activation level (e.g., the logic high level). The servo controller 100 enters the second operation mode, cuts off the error signal ES, and sets the internal parameter to the kick parameter. In the first time period of the second operation mode (from time t1 to time t2), the servo controller 100 adjusts the level of the driving control signal DCON based on the kick parameter. The driving control signal DCON has a kick peak value pk at a point in time at which the internal parameter is set to the kick parameter (e.g., at time t1), and exponentially decreases during the first time period of the second operation mode.

As described above with reference to FIGS. 4 and 6, at time t2, the error signal ES complies with the brake criterion, in other words, the error signal ES has a brake level Vbc. The servo controller 100 allows a reception of the error signal ES, and sets the internal parameter to the brake parameter. In the second time period of the second operation mode (from time t2 to time t3), the servo controller 100 adjusts the level of the driving control signal DCON based on the brake parameter and the error signal ES. The driving control signal DCON has a brake peak value pb at a point in time at which the internal parameter is set to the brake parameter (e.g., at time t2), and inverse exponentially increases during the second time period of the second operation mode.

At time t3, the external control signal ECON is transitioned from the activation level to the deactivation level. The servo controller 100 enters the first operation mode, and sets the internal parameter to the normal parameter.

Although not illustrated in FIG. 7A, in another exemplary embodiment of the inventive concept, the driving control signal DCON may have another kick peak value at the point in time at which the internal parameter is set to the kick parameter, may inverse exponentially increase during the first time period of the second operation mode, may have another brake peak value at the point in time at which the internal parameter is set to the brake parameter, and may exponentially decrease during the second time period of the second operation mode.

Referring to FIGS. 7A, 7B, 7C and 7D, before time t1, the position of the driven device is maintained at an initial position y1. The driven device is not moved, and thus the velocity of the driven device and the acceleration of the driven device are about zero, respectively.

At time t1, the internal parameter is set to the kick parameter, and the driven device starts to move toward a final position y2. From time t1 to time t2, the driven device is moved from the initial position y1 to a brake position ybc. The brake position ybc may correspond to a position of the driven device at a point in time at which the error signal ES has the brake level Vbc. The velocity of the driven device increases from about zero to a velocity vm. The acceleration of the driven device instantly or rapidly increases at time t1, and thereafter exponentially decreases to about zero.

To stop the movement of the driven device, the internal parameter is set to the brake parameter at time t2. The driven device does not stop immediately after the internal parameter is set to the brake parameter due to inertial force, and thus the servo controller 100 sets the internal parameter to the brake parameter when the driven device is in the brake position ybc before the driven device has arrived at the final position y2. From time t2 to time t3, the driven device is moved from the brake position ybc to the final position y2 based on the inertial force. The velocity of the driven device decreases from the velocity vm to about zero. The acceleration of the driven device instantly or rapidly decreases at time t2, and thereafter inverse exponentially increases to about zero.

At time t3, the movement of the driven device is stopped. After time t3, the position of the driven device is maintained at the final position y2. The driven device is not moved, and thus the velocity of the driven device and the acceleration of the driven device are about zero, respectively.

In a servo system including the servo controller 100 according to an exemplary embodiment of the inventive concept, as illustrated in FIG. 7C, the driven device may have a relatively long time interval during which the velocity of the driven device is substantially the same as about zero in the second time period of the second operation time (e.g., from time t2 to time t3, or from a point after time t2 to time t3). In other words, the servo controller 100 may effectively reduce the terminal velocity of the driven device to about zero. Thus, the servo controller 100 may effectively control the plant and the driven device included in the plant, and the servo system including the servo controller 100 may have relatively high operation speed, high operation reliability and high operation stability.

FIG. 8 is a block diagram illustrating a servo system according to an exemplary embodiment of the inventive concept.

Referring to FIG. 8, a servo system 200 includes a plant 210, a servo controller 220 and a driver 230. The servo system 200 may further include a sensor 240, a calculator 250 and an amplifier 260.

The plant 210 includes a driven device 212 that performs a steady-state operation in a first operation mode and a target moving operation in a second operation mode based on a driving signal DRV. The driven device 212 may perform a circular movement or a linear movement, according to exemplary embodiments. Although not illustrated in FIG. 8, the plant 210 may further include various other elements for the driven device 212 and/or the servo system 200.

The sensor 240 may generate a feedback signal FBS by detecting a position or a velocity of the driven device 212. The feedback signal FBS may correspond to a current position or a current velocity of the driven device 212. The sensor 240 may include an infrared light sensor, an ultrasonic wave sensor, an optical sensor, etc.

The calculator 250 may generate a difference signal DFS by subtracting the feedback signal FBS from a reference signal RS. The reference signal RS may correspond to a target position or a target velocity of the driven device 212, and may be used to determine whether the driven device maintains a steady-state.

The amplifier 260 may generate the error signal ES by amplifying the difference signal DFS. The error signal ES may correspond to a difference between the reference signal RS and the feedback signal FBS, and may correspond to the position or the velocity of the driven device 212.

The servo controller 220 may be the servo controller 100 of FIG. 1. The servo controller 220 may include a kick/brake control unit 222 and a compensation unit 224. The servo controller 220 determines an internal parameter based on an external control signal ECON and an operation state of the driven device 212, and generates a driving control signal DCON based on the error signal ES and the internal parameter. The servo controller 220 may include a single compensation unit 224 that is enabled in both of the first and second operation modes instead of two compensation units that are alternately enabled depending on the operation mode. and the compensation unit 224 may determine the internal parameter depending on operating environments of the servo system 200, thereby controlling the plant 210 and the driven device 212. The driver 230 generates the driving signal DRV based on the driving control signal DCON.

described above with reference to FIG. 1, the servo controller 220 may set the internal parameter to a kick parameter when the external control signal ECON is transitioned from a deactivation level to an activation level in the second operation mode, and may set the internal parameter to a brake parameter when the external control signal ECON is maintained at the activation level and the error signal ES complies with a brake criterion in the second operation mode. The kick parameter may be used to start the target moving operation of the driven device 212, and the brake parameter may be used to finish the target moving operation of the driven device 212.

In a first time period of the second operation mode during which the internal parameter is set to the kick parameter, the servo controller 220 may cut off the error signal ES received from the amplifier 260. The amplifier 260 may temporarily initialize the error signal ES in the first time period of the second operation mode. For example, a gain of the amplifier 260 may be set to about zero based on the external control signal ECON in the first time period of the second operation mode, and thus the servo controller 220 may cut off the error signal ES by receiving the error signal ES that has a level corresponding to about zero.

In an exemplary embodiment of the inventive concept, the servo system 200 may be a system that drives an optical disc (e.g., an optical disc driving device) that has a plurality of data layers. Each data layer may store data, and may have a different depth from a surface of the optical disc. In this embodiment, the servo controller 220 may be a focus servo controller for controlling a layer-jump operation to move a light spot projected on the optical disc from a first data layer to a second data layer of the plurality of data layers.

Hereinafter, a servo system according to an exemplary embodiment of the inventive concept will be explained in detail with reference to exemplary configurations of the optical disc driving device and the optical disc.

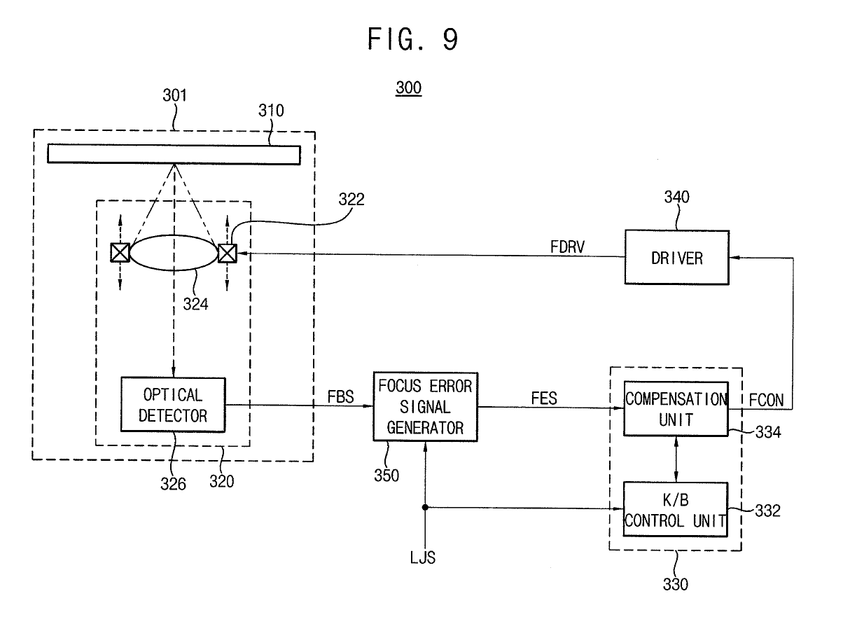

FIG. 9 is a block diagram illustrating an optical disc driving device according to an exemplary embodiment of the inventive concept.

Referring to FIG. 9, an optical disc driving device 300 includes an optical disc control unit 301, a focus error signal generator 350, a focus servo controller 330 and a focus driver 340.

The optical disc control unit 301 may include an optical disc 310 and an optical pick-up unit 320. Although not illustrated in FIG. 9, the optical disc control unit 301 may further include a spindle motor and a step motor for moving the optical pick-up unit 320.

The optical disc 310 may be one of various recoding mediums that store data such as image data, sound data, etc. For example, the optical disc 310 may be a compact disc (CD), a laser disc (LD), a digital versatile disc (DVD), a blu-ray disc, etc.

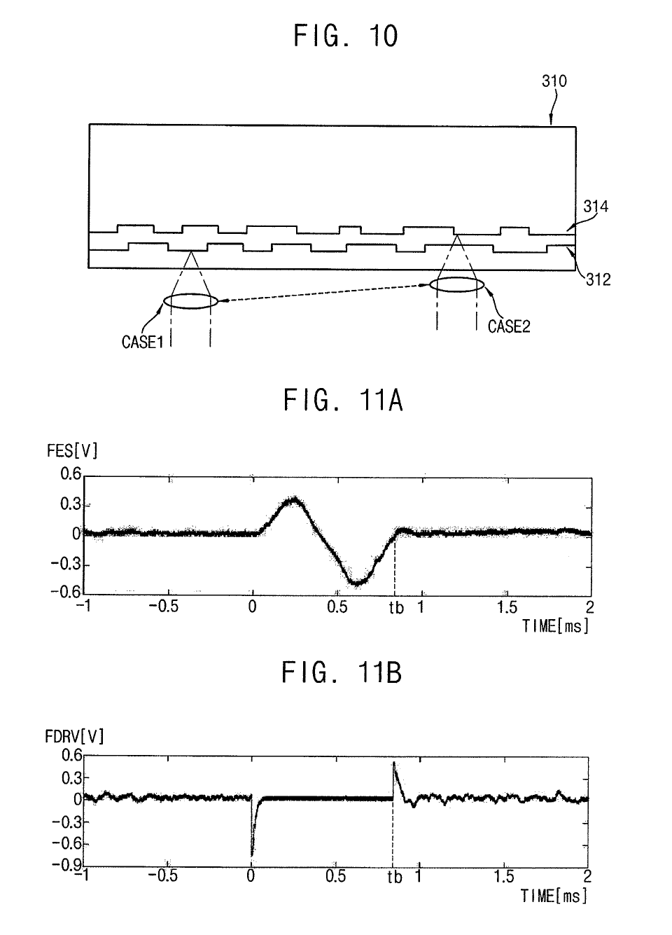

FIG. 10 is a cross-sectional view illustrating an example of an optical disc that may be used in the optical disc driving device of FIG. 9.

Referring to FIG. 10, the optical disc 310 may include a plurality of data layers 312 and 314. Each of the data layers 312 and 314 may store data and may have a different depth from a surface of the optical disc 310. Although not illustrated in detail in FIG. 10, a hard coating layer and a transparent cover layer may be formed beneath a first data layer 312, a space layer may be formed between the first data layer 312 and a second data layer 314, and a substrate may be formed on the second data layer 314. The substrate may include a polycarbonate material. Although the optical disc 310 including two data layers is illustrated in FIG. 10, the number of the data layers included in the optical disc 310 is not limited thereto.

An optical disc driving device may store data in an optical disc or may read data stored in an optical disc based on a light signal. To accurately store data in the optical disc or read stored data from the optical disc, the light signal (e.g., a light spot) needs to be precisely projected on a data layer in the optical disc. In addition, in a multi-layer optical disc including a plurality of data layers, a layer-jump operation may be performed during a read operation or a write operation. For example, if the optical disc driving device reads data that is continuously stored in two adjacent data layers of the optical disc, the light spot may be projected on one data layer to read a front portion of the stored data, may be moved from the one data layer to another data layer, and may be projected on the another data layer to read a back portion of the stored data. As illustrated in FIG. 10, the light spot may be projected on the first data layer 312 (e.g., CASE1) or on the second data layer 314 (e.g., CASE2), and may be moved from the first data layer 312 to the second data layer 314 or from the second data layer 314 to the first data layer 312 depending on a control operation of the focus servo controller 330.

Referring back to FIG. 9, the optical pick-up unit 320 may include an actuator 322 (e.g., a motor), an object lens 324 and an optical detector 326. Although not illustrated in FIG. 9, the optical pick-up unit 320 may further include a laser diode, a beam splitter, etc. The optical pick-up unit 320 may generate a light spot for reading data stored in an optical disc 310 or storing data in the optical disc 310, may control a position of the light spot based on a focus driving signal FDRV, and may generate a feedback signal FBS based on a light reflected from the optical disc 310.

A light signal may be emitted by the laser diode (not illustrated), and may be split by the beam splitter (not illustrated). The object lens 324 may collects the split light to generate the light spot. The actuator 322 may control the position of the object lens 324 based on the focus driving signal FDRV such that the light spot provided from the object lens 324 is projected on a target data layer of the optical disc 310. For example, the actuator 322 may perform a steady-state operation in a first operation mode by maintaining the position of the object lens 324 at a target position, and may perform a target moving operation in a second operation mode by moving the object lens 324 from a first position (e.g., an initial position) to a second position (e.g., a final position). The optical detector 326 may detect the reflected light from the optical disc 310 to generate the feedback signal FBS that corresponds to a current position of the object lens 324.

The focus error signal generator 350 may generate a focus error signal FES based on the feedback signal FBS and a reference signal that corresponds to the target position of the object lens 324. The focus error signal generator 350 may generate the focus error signal FES by using a predetermined scheme such as an astigmatism scheme, a knife edge scheme, etc.

The focus servo controller 330 may be substantially the same as the servo controller 100 of FIG. 1. The focus servo controller 330 may include a kick/brake control unit 332 and a compensation unit 334. The kick/brake control unit 332 may determine an internal parameter based on a layer-jump control signal US and an operation state of the actuator 322. The compensation unit 334 may generate a focus control signal FCON based on the focus error signal FES and the internal parameter. The focus driver 340 may generate the focus driving signal FDRV based on the focus control signal FCON.

In an exemplary embodiment of the inventive concept, the focus error signal generator 350 may temporarily initialize the focus error signal FES in a first time period of the second operation mode during which the internal parameter is set to a kick parameter. The focus servo controller 330 may cut off the focus error signal FES received from the focus error signal generator 350 in the first time period of the second operation mode.

In an exemplary embodiment of the inventive concept, the focus error signal generator 350, the focus servo controller 330 and focus driver 340 may be fabricated as a single integrated circuit (IC) chip such as a system-on-chip (SoC). In this embodiment, the system-on-chip may further include an analog front-end (AFE), an analog-to-digital converter, a digital front-end (DFE), a digital-to-analog converter, etc.

In FIG. 9, the actuator 322 and the object lens 324 may correspond to the driven device 212 in FIG. 8. The optical detector 326 may correspond to the sensor 240 in FIG. 8. The optical disc control unit 301 may correspond to the plant 210 and the sensor 240 in FIG. 8. The focus error signal generator 350 may correspond to the calculator 250 and the amplifier 260 in FIG. 8. The focus servo controller 330 may correspond to the servo controller 220 in FIG. 8. The focus driver 340 may correspond to the driver 230 in FIG. 8.

An operation of the actuator 322 included in the optical disc driving device 300 may be modeled as the mass-spring-damper system. For example, a transfer function H(s) of the actuator 322 may be represented by Equation 1.

$$H ( s ) = \frac{{K}_{n} {ω}_{n}^{2}}{{s}^{2} + 2 {ζω}_{n} s + {ω}_{n}^{2}} \qquad [ Equation 1 ]$$

In Equation 1, Kₙ represents a direct current (DC) sensitivity of the actuator 322, ωₙ represents a natural undamped frequency of the actuator 322, and ζ represents a damping ratio of the actuator 322.

A total response of a system may be calculated by adding a zero-input response of the system to a zero-state response of the system. Thus, a total response of the actuator 322 may be represented by Equation 2.

$$Y ( s ) = L \{ {R}_{ZS} \} + L \{ {R}_{ZI} \} + \frac{{K}_{n} {ω}_{n}^{2}}{{s}^{2} + 2 {ζω}_{n} s + {ω}_{n}^{2}} X ( S ) + \frac{( s + 2 {ζω}_{n} ) y ( 0 ) + {y}^{′} ( 0 )}{{s}^{2} + 2 {ζω}_{n} s + {ω}_{n}^{2}} \qquad [ Equation 2 ]$$

In Equation 2, L{A} represents a Laplace transform on A, R_{ZS} represents a zero-state response of the actuator 322, R_{ZI} represents a zero-input response of the actuator 322, X(s) represents an input of the actuator 322 processed by the Laplace transform, and Y(s) represents an output of the actuator 322 processed by the Laplace transform. X(s) may correspond to the focus driving signal FDRV input to the actuator 322, and Y(s) may correspond to the position of the actuator 322. A variation of the position of the actuator 322 may be obtained by performing an inverse Laplace transform on Y(s) of Equation 2.

The focus driving signal FDRV may be substantially the same as the focus control signal FCON, and the focus control signal FCON may be similar to the driving control signal DCON illustrated in FIG. 7A. For example, the focus control signal FCON may be an exponentially decaying function (EDF), in other words, the focus control signal FCON may exponentially increase or decrease. When the focus control signal FCON is an EDF, the focus driving signal FDRV may be similar to a step response of a high pass filter or an impulse response of a low pass filter. Assuming that the focus driving signal FDRV is similar to the step response of the high pass filter, the focus driving signal FDRV may be represented by Equation 3.

$$X ( s ) = \frac{\frac{s}{{ω}_{h}}}{\frac{s}{{ω}_{h}} + 1} \cdot \frac{{K}_{Lvl}}{s} = \frac{{K}_{Lvl}}{s + {ω}_{h}} \qquad [ Equation 3 ]$$

In Equation 3, X(s) represents the focus driving signal FDRV processed by the Laplace transform, K_{Lvl} represents a level of the focus driving signal FDRV, and ωₕ represents a cut-off frequency of the high pass filter.

In the first operation mode (e.g., a steady-state operation mode), the position of the actuator 322 is maintained at the first position. The focus error signal FES and the focus driving signal FDRV may be substantially the same at about zero, and an initial condition (e.g., an initial state) of the actuator 322 at the starting point of the first time period of the second operation mode may be about zero. Thus, in the first time period of the second operation mode, the total response of the actuator 322 may be determined based on only the zero-state response of the actuator 322. A position y₁(t), a velocity v₁(t) and an acceleration a₁ᵢ(t) of the actuator 322 in the first time period of the second operation mode may be represented by Equation 4, Equation 5 and Equation 6, respectively.

$$\begin{matrix} {y}_{1} ( t ) = {K}_{kick} {K}_{γ} [ {K}_{ζ} {e}^{- {ω}_{h} t} + {f}_{1} ( t ) + \frac{{ω}_{h} - 2 {ζω}_{n}}{{ω}_{n}} {f}_{0} ( t ) ] & [ Equation 4 ] \\ {v}_{1} ( t ) = - {K}_{kick} {K}_{γ} [ {K}_{ζ} {ω}_{h} {e}^{- {ω}_{h} t} + {ω}_{n} {f}_{2} ( t ) + ( {ω}_{h} - 2 {ζω}_{n} ) {f}_{1} ( t ) ] & [ Equation 5 ] \\ {a}_{1} ( t ) = {K}_{kick} {K}_{γ} [ {K}_{ζ} {ω}_{h}^{2} {e}^{- {ω}_{h} t} + {ω}_{n}^{2} {f}_{3} ( t ) + ( {ω}_{h} - 2 {ζω}_{n} ) {ω}_{n} {f}_{2} ( t ) ] & [ Equation 6 ]\end{matrix}$$

Equation 4 is obtained by performing the inverse Laplace transform on the zero-state response of the actuator 322 of Equation 2. Equation 5 is obtained by differentiating Equation 4, and Equation 6 is obtained by differentiating Equation 5. In Equations 4, 5 and 6, K_{kick} represents a kick level (e.g., a kick peak value) of the focus driving signal FDRV corresponding to K_{Lvl} in Equation 3. K_{ζ}, K_{γ} and fₖ(t) are coefficients that are defined for convenience of description, and are represented by Equation 7, Equation 8 and Equation 9, respectively.

$$\begin{matrix}{K}_{ζ} = \frac{1}{\sqrt{1 - {ζ}^{2}}} & [ Equation 7 ] \\ {K}_{γ} = \frac{1}{{K}_{ζ}} \cdot \frac{{K}_{n} {ω}_{n}^{2}}{{ω}_{n}^{2} + {ω}_{h}^{2} - 2 {ζω}_{h} {ω}_{n}} & [ Equation 8 ] \\ {f}_{k} ( t ) = {e}^{- {ζω}_{n} t} sin ( \sqrt{1 - {ζ}^{2}} {ω}_{n} t - k θ ) , θ = {cos}^{- 1} ζ & [ Equation 9 ]\end{matrix}$$

In Equation 9, k is an arbitrary real number.

When the focus error signal FES complies with a brake criterion, in other words, when the focus error signal FES has a predetermined brake level, a braking operation for finishing the target moving operation is performed, and the second time period of the second operation mode begins. In the first time period of the second operation mode, the actuator 322 is moved from the first position to the second position, the focus error signal FES and the focus driving signal FDRV may be not about zero, and thus an initial condition of the actuator 322 at the starting point of the second time period of the second operation mode may be not about zero. Thus, in the second time period of the second operation mode, the total response of the actuator 322 may be determined based on both of the zero-state response and the zero-input response of the actuator 322. A position y₂(t), a velocity v₂(t) and an acceleration a₂(t) of the actuator 322 in the second time period of the second operation mode may be represented by Equation 10, Equation 11 and Equation 12, respectively.

$$\begin{matrix}{y}_{2} ( t ) = {K}_{brake} {K}_{γ} [ \frac{1}{{K}_{ζ}} {e}^{- {ω}_{h} ( t - {t}_{b} )} + {f}_{1} ( t - {t}_{b} ) + \frac{{ω}_{h} - 2 {ζω}_{n}}{{ω}_{n}} {f}_{0} ( t - {t}_{b} ) ] + \frac{1}{{K}_{ζ}} [ - y ( {t}_{b} ) {f}_{1} ( t - {t}_{b} ) + \frac{{K}_{h}}{{ω}_{n}} {f}_{0} ( t - {t}_{b} ) ] & [ Equation 10 ] \\ {v}_{2} ( t ) = - {K}_{brake} {K}_{γ} [ {K}_{ζ} {ω}_{h} {e}^{- {ω}_{h} ( t - {t}_{b} )} + {ω}_{n} {f}_{2} ( t - {t}_{b} ) + ( {ω}_{h} - 2 {ζω}_{n} ) {f}_{1} ( t - {t}_{b} ) ] + \frac{1}{{K}_{ζ}} [ {ω}_{n} y ( {t}_{b} ) {f}_{2} ( t - {t}_{b} ) - {K}_{h} {f}_{1} ( t - {t}_{b} ) ] & [ Equation 11 ] \\ {a}_{2} ( t ) = - {K}_{brake} {K}_{γ} [ {K}_{ζ} {ω}_{h}^{2} {e}^{- {ω}_{h} ( t - {t}_{b} )} + {ω}_{n}^{2} {f}_{3} ( t - {t}_{b} ) + ( {ω}_{h} - 2 {ζω}_{n} ) {ω}_{n} {f}_{2} ( t - {t}_{b} ) ] + \frac{1}{{K}_{ζ}} [ - {ω}_{n}^{2} y ( {t}_{b} ) {f}_{3} ( t - {t}_{b} ) - {ω}_{n} {K}_{h} {f}_{2} ( t - {t}_{b} ) ] & [ Equation 12 ]\end{matrix}$$

Equation 10 is obtained by performing the inverse Laplace transform on the zero-state response and the zero-input response of the actuator 322 in the Equation 2. Equation 11 is obtained by differentiating the Equation 10, and Equation 12 is obtained by differentiating Equation 11. In Equations 10, 11 and 12, K_{brake} represents a brake level (e.g., a brake peak value) of the focus driving signal FDRV corresponding to K_{Lvl} in Equation 3, and t_{b} represents a point in time at which the focus error signal FES complies with the brake criterion. Kₕ is a coefficient that is defined for convenience of description, and is represented by Equation 13.

Kₕ=2ζωₙy(t_{b})+v(t_{b}) [Equation 13]

In addition, the optical disc driving device 300 may operate in a gravity field. A periodic disturbance may occur when the optical disc 310 performs a circular movement. Thus, a real position yᵣ(t), a real velocity vᵣ(t) and a real acceleration aᵣ(t) in the second operation mode that are affected by a gravity force and the disturbance may be represented by Equation 14, Equation 15 and Equation 16, respectively.

yᵣ(t)=y(t)+R sin (ωᵣ(t−η))±½Gt² [Equation 14]

vᵣ(t)=v(t)+Rωᵣ cos(ωᵣ(t−η))±Gt [Equation 15]

aᵣ(t)=a(t)−Rωᵣ² sin(ωᵣ(t−η))±G [Equation 16]

In Equation 14, y(t) represents the position of the actuator 322 during an entire second operation mode, and corresponds to a sum of y₁(t) of Equation 4 and y₂(t) of Equation 10. In Equation 15, v(t) represents the velocity of the actuator 322 during the entire second operation mode, and corresponds to a sum of v₁(t) of Equation 5 and y₂(t) of Equation 11. In Equation 16, a(t) represents the acceleration of the actuator 322 during the entire second operation mode, and corresponds to a sum of a₁(t) of Equation 6 and a₂(t) of the Equation 12. In Equations 14, 15 and 16, R represents a run-out period of an outside edge of the optical disc 310, ωᵣ represents a revolution frequency of the optical disc 310, η represents a phase of a current position of the optical disc 310, and G represents an acceleration of gravity. A sign of the acceleration of gravity G may be determined depending on a moving direction of the light spot.

The operation of the optical disc driving device 300 may be determined based on such Equations. For example, the revolution frequency of the optical disc 310 (ωᵣ), the target distance between the first position (e.g., the first data layer 312) and the second position (e.g., the second data layer 314), and the target time required to move the actuator 322 from the first position to the second position may be determined based on a specification of the optical disc driving device 300. The run-out period of the outside edge of the optical disc 310 (R) and the phase of the current position of the optical disc 310 (η) may be measured depending on the operation state of the optical disc driving device 300. Thus, the kick level K_{kick} of the focus driving signal FDRV may be determined from Equation 14. The kick parameter may be determined based on the kick level K_{kick}.

In addition, the brake criterion of the focus error signal FES may be determined based on the specification of the optical disc driving device 300. The velocity v(t_{b}) of the actuator 322 at a point in time (t_{b}) at which the focus error signal FES complies with the brake criterion may be determined from Equation 15. Thus, the brake level K_{brake} of the focus driving signal FDRV may be determined based on the velocity v(t_{b}) at time t_{b} such that a terminal velocity of the actuator 322 at the ending point of the second time period of the second operation mode is reduced to about zero based on the brake level K_{brake}. The brake parameter may be determined based on the brake level K_{brake}.

In the optical disc driving device 300 according to an exemplary embodiment of the inventive concept, the focus servo controller 330 may include a single compensation unit 334 that is always enabled (e.g., enabled in both of the first and second operation modes), instead of two compensation units that are alternately enabled depending on the operation mode. In addition, the internal parameter may be determined depending on operating environments of the optical disc driving device 300. Thus, the optical disc driving device 300 may have high operation speed, high operation reliability and high operation stability.

FIGS. 11A, 11B, 12A, 12B, 13A, 13B, 14A, 14B, 15A and 15B are diagrams for describing exemplary operations of the optical disc driving device of FIG. 9.

FIG. 11A illustrates a variation of a voltage level of the focus error signal FES depending on the layer-jump operation. FIG. 11B illustrates a variation of a voltage level of the focus driving signal FDRV depending on the layer-jump operation. In FIGS. 11A and 11B, the light spot is moved in a downward direction, in other words, the light spot is moved from an upper data layer (e.g., the second data layer 314 in FIG. 10) to a lower data layer (e.g., the first data layer 312 in FIG. 10).

Referring to FIGS. 11A and 11B, a kick operation is performed at about time zero, and a brake operation is performed at about time tb. The focus driving signal FDRV instantly or rapidly decreases to a first kick peak value at about time zero, inverse exponentially increases until about time tb, instantly or rapidly increases to a first brake peak value at about time tb, and exponentially decreases. In addition, a focus servo-on operation for maintaining the light spot on the first data layer 312 is performed at about time tb. As illustrated in FIG. 11A, an overshoot of the focus error signal FES (e.g., an overshoot of the actuator 322) at about time tb is very small. Thus, the optical disc driving device 300 may have relatively high operation reliability and high operation stability.

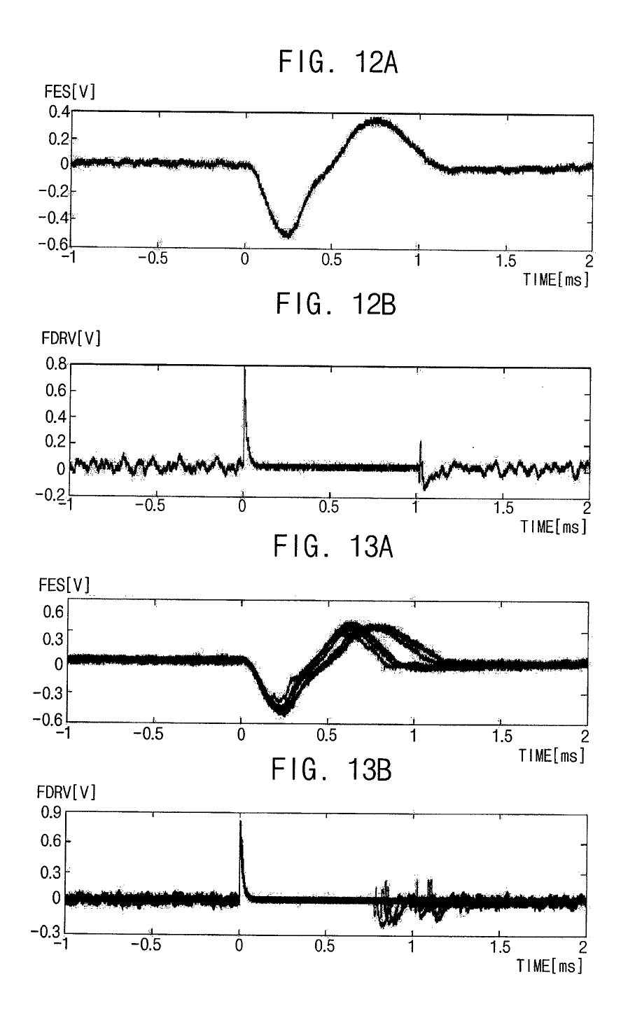

FIG. 12A illustrates the variation of the voltage level of the focus error signal FES depending on the layer-jump operation. FIG. 12B illustrates the variation of the voltage level of the focus driving signal FDRV depending on the layer-jump operation. In FIGS. 12A and 12B, the light spot is moved toward an upward direction, in other words, the light spot is moved from the lower data layer (e.g., the first data layer 312 in FIG. 10) to the upper data layer (e.g., the second data layer 314 in FIG. 10).

Referring to FIGS. 12A and 12B, a kick operation is perfoiiiied at about time zero, and a brake operation is performed at about time one. The focus driving signal FDRV instantly or rapidly increases to a second kick peak value at about time zero, exponentially decreases until about time one, instantly or rapidly decreases to a second brake peak value at about time one, and inverse exponentially increases. A sign of the second kick peak value is opposite to a sign of the first kick peak value, and a sign of the second brake peak value is opposite to a sign of the first brake peak value since a direction of the layer-jump operation in FIGS. 12A and 12B is opposite to a direction of the layer-jump operation in FIGS. 11A and 11B. In addition, a focus servo-on operation for maintaining the light spot on the second data layer 314 is performed at about time one. As illustrated in FIG. 12A, an overshoot of the focus error signal FES (e.g., an overshoot of the actuator 322) about time one is very small. Thus, the optical disc driving device 300 may have relatively high operation reliability and high operation stability.

FIG. 13A illustrates the variations of the voltage level of the focus error signal FES when the light spot is moved in the downward direction. In FIG. 13A, the layer-jump operation is repeated five times, and the five graphs of the focus error signal FES are overlapped. FIG. 13B illustrates the variations of the voltage level of the focus driving signal FDRV when the light spot is moved in the downward direction. In FIG. 13B, the layer-jump operation is repeated five times, and the five graphs of the focus driving signal FDRV are overlapped. FIGS. 13A and 13B are similar to FIGS. 11A and 11B, respectively.

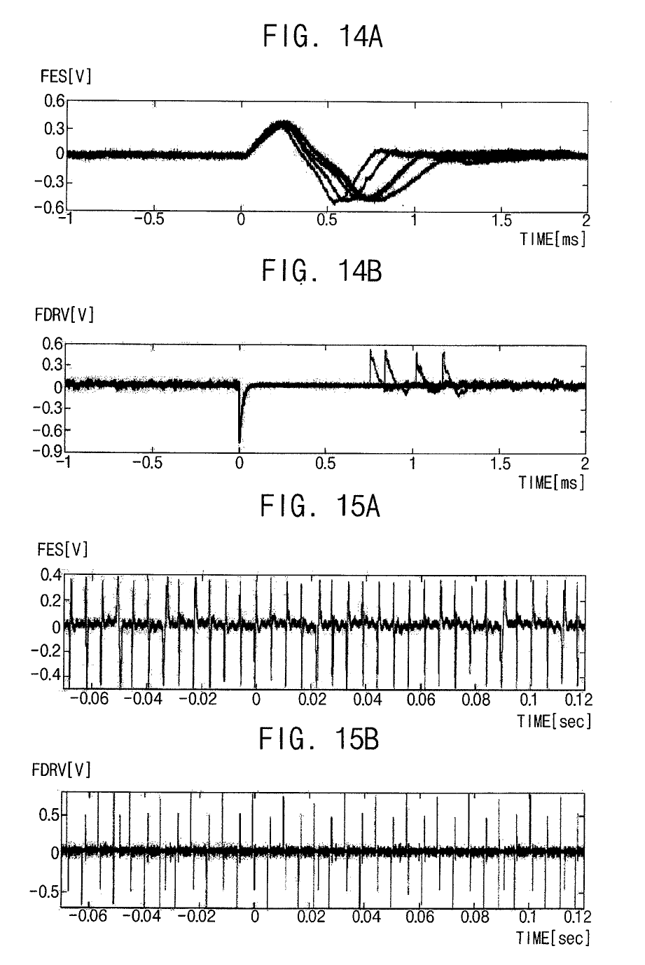

FIG. 14A illustrates the variations of the voltage level of the focus error signal FES when the light spot is moved in the upward direction. In FIG. 14A, the layer-jump operation is repeated five times, and the five graphs of the focus error signal FES are overlapped. FIG. 14B illustrates the variations of the voltage level of the focus driving signal FDRV when the light spot is moved in the upward direction. In FIG. 14B, the layer-jump operation is repeated five times, and the five graphs of the focus driving signal FDRV are overlapped. FIGS. 14A and 14B are similar to FIGS. 12A and 12B, respectively.

FIG. 15A illustrates the variation of the voltage level of the focus error signal FES when the layer-jump operation is continuously performed for about 5 ms. FIG. 15B illustrates the variation of the voltage level of the focus driving signal FDRV when the layer-jump operation is continuously performed for about 5 ms. Referring to FIGS. 15A and 15B, even though the layer-jump operation is continuously performed for a relatively short time interval, the optical disc driving device 300 may have relatively high operation reliability and high operation stability.

At least one of the above described embodiments may be employed in any system performing a servo control. Thus, at least one embodiment of the present inventive concept may be applied to a driving system for a recording medium such as an optical disc or a hard disk drive, an industrial robot, a plane, a ship, a vehicle, etc.

The foregoing is illustrative of exemplary embodiments of the inventive concept and is not to be construed as limiting thereof Although a few exemplary embodiments of the inventive concept have been described, many modifications can be made in the exemplary embodiments without materially departing from the present inventive concept. Accordingly, all such modifications are intended to be included within the scope of the present inventive concept.

What is claimed is:

1. A servo controller, comprising:
a kick/brake control unit configured to determine an internal parameter based on an external control signal and an operation state of a plant; and
a compensation unit configured to generate a driving control signal based on an error signal supplied from the plant and the internal parameter, and configured to supply the driving control signal to the plant,
wherein the plant performs a steady-state operation during a first operation mode and a target moving operation during a second operation mode based on the driving control signal.

2. The servo controller of claim 1,
wherein the kick/brake control unit sets the internal parameter to a kick parameter when the external control signal is transitioned from a deactivation level to an activation level during the second operation mode, and sets the internal parameter to a brake parameter when the external control signal is maintained at the activation level and the error signal complies with a brake criterion during the second operation mode, and
wherein the kick parameter is used to start the target moving operation of the plant, and the brake parameter is used to finish the target moving operation of the plant.

3. The servo controller of claim 2,
wherein the compensation unit adjusts a level of the driving control signal based on the kick parameter during a first time period of the second operation mode, and adjusts the level of the driving control signal based on the brake parameter and the error signal during a second time period of the second operation mode, and
wherein the internal parameter is set to the kick parameter during the first time period of the second operation mode and set to the brake parameter during the second time period of the second operation mode.

4. The servo controller of claim 3,
wherein the driving control signal has a kick peak value at a starting point of the first time period of the second operation mode, and exponentially increases or decreases during the first time period of the second operation mode, and
wherein the driving control signal has a brake peak value at a starting point of the second time period of the second operation mode, and exponentially increases or decreases during the second time period of the second operation mode.

5. The servo controller of claim 3, wherein the compensation unit cuts off the error signal received from the plant during the first time period of the second operation mode, and allows the error signal to be received from the plant during the second time period of the second operation mode.

6. The servo controller of claim 2,
wherein the kick/brake control unit sets the internal parameter to a normal parameter when the external control signal is transitioned from the activation level to the deactivation level during the first operation mode, and
wherein the normal parameter is used to perform the steady-state operation of the plant.

7. The servo controller of claim 2,
wherein the target moving operation of the plant indicates that a driven device included in the plant moves from a first position to a second position, and
wherein the kick parameter is determined based on a disturbance of the plant, a target distance between the first position and the second position, and a target time required to move the driven device from the first position to the second position.

8. The servo controller of claim 7, wherein the brake parameter is determined based on a velocity of the driven device at a point in time at which the error signal complies with the brake criterion.

9. The servo controller of claim 1, wherein the compensation unit is an N-th order digital filter having N stages, where N is a natural number >=two, each stage in the N-th order digital filter having a delay memory, and
wherein the kick/brake control unit corresponds to one of the delay memories.

10. The servo controller of claim 9, wherein the kick/brake control unit corresponds to a delay memory that is included in a last stage of the N stages that is adjacent an output terminal of the N-th order digital filter.

11. A servo system comprising:
a plant including a driven device, the driven device performing a steady-state operation during a first operation mode and a target moving operation during a second operation mode based on a driving signal;
a servo controller configured to determine an internal parameter based on an external control signal and an operation state of the driven device, and configured to generate a driving control signal based on an error signal and the internal parameter, the error signal corresponding to a position or a velocity of the driven device; and
a driver configured to generate the driving signal based on the driving control signal.

12. The servo system of claim 11, further comprising:
a sensor configured to generate a feedback signal by detecting a current position or a current velocity of the driven device.

13. The servo system of claim 12, further comprising:
a calculator configured to generate a difference signal by subtracting the feedback signal from a reference signal; and
an amplifier configured to generate the error signal by amplifying the difference signal.

14. The servo system of claim 13, wherein the servo controller sets the internal parameter to a kick parameter when the external control signal is transitioned from a deactivation level to an activation level during the second operation mode, and sets the internal parameter to a brake parameter when the external control signal is maintained at the activation level and the error signal complies with a brake criterion during the second operation mode,
wherein the kick parameter is used to start the target moving operation of the driven device, and the brake parameter is used to finish the target moving operation of the driven device, and
wherein the amplifier temporarily initializes the error signal during a time period of the second operation mode during which the internal parameter is set to the kick parameter.

15. The servo system of claim 11, wherein the servo system is a system configured to drive an optical disc that has a plurality of data layers, each data layer storing data and having a different depth from a surface of the optical disc, and
wherein the servo controller is a focus servo controller configured to control a layer-jump operation to move a light spot projected on the optical disc from a first data layer to a second data layer of the plurality of data layers.

16. A servo system comprising:
a controller configured to output a first value during a first period of an activated control signal, and a second other value during a second remaining period of the activated control signal; and
a compensating unit configured to generate a first driving signal to start moving a device of the system when the output is the first value, and generate a second driving signal based on an error signal to stop moving the device when the output is the second value.

17. The servo system of claim 16, wherein the controller outputs a third value different from the first and second values when the control signal is deactivated, and
wherein the compensating unit generates a third driving signal to maintain a position of the driven device at a pre-defined position or within a pre-defined position range when the output is the third value.

18. The servo system of claim 16, further comprising a unit to output the error signal to the compensating unit with a reduced voltage when a voltage of the error signal differs from a pre-defined breaking voltage.

19. The servo system of claim 16, further comprising an amplifier that outputs the error signal, wherein a gain of the amplifier is set to zero during the first period.

20. The servo system of claim 19, further comprising:
a sensor configured to determine a current position of the device; and
an adder configured to output a difference of a reference signal and the determined position to the amplifier.
